(19) United States
(12) Patent Application Publication
(10) Pub. No.: US 2002/0094797 A1
(43) Pub. Date: Jul. 18, 2002

(54) Connectionless broadcast signalling

(75) Inventors: Christopher B. Marshall, Haywards Heath (GB); Robert J. Davies, Horley (GB)

Correspondence Address: Corporate Patent Counsel, U.S. Philips Corporation, 580 White Plains Road, Tarrytown, NY, 10591, US

(73) Assignee: KONINKLIJKE PHILLIPS ELECTRONICS N.V.

(21) Appl. No.: 10/046,993

(22) Filed: Jan. 15, 2002

(30) Foreign Application Priority Data
Jan. 18, 2001 (GB) 0101292.1
Dec. 5, 2001 (GB) 0129063.4

(51) Int. Cl. H04M 11/00

(52) U.S. Cl. 455/403; 455/517; 455/41

(57) ABSTRACT

A communications system comprises a beacon and at least one portable device for receiving data from the beacon. The beacon broadcasts messages using a first protocol which provides a series of inquiry messages which hop frequencies (such as Bluetooth). Additional data is broadcast using a spread spectrum transmission technique. These two modes enable the spread spectrum transmission technique to be used to enable an unsynchronized receiver to establish communication in a short time, so that data can be sent to the receiver as quickly as possible. The frequency hopping technique may require a longer call set-up procedure, but provides a more appropriate communications protocol for bi-directional transfer of larger quantities of data.

The present invention relates to services offered to users of electronic equipment, especially but not exclusively to users of mobile communications devices such as portable telephones and suitably equipped PDA's (personal digital assistants). The invention further relates to means for delivery of such services, and to portable devices for receiving them.

Recent years have seen a great increase in subscribers world-wide to mobile telephone networks and, through advances in technology and the addition of functionalities, cellular telephones have become personal, trusted devices. A result of this is that a mobile information society is developing, with personalised and localised services becoming increasingly more important. Such “Context-Aware” (CA) mobile telephones are used with low power, short range base stations in places like shopping malls to provide location-specific information. This information might include local maps, information on nearby shops and restaurants and so on. The user's CA terminal may be equipped to filter the information received according to pre-stored user preferences and the user is only alerted if an item of data of particular interest has been received.

It will be recognised that an important requirement for CA devices is that they quickly and efficiently gather data from beacons such that the user is not required to undertake actions such as staying close to a beacon whilst contact is established between portable device and beacon, nor having to specifically initiate interaction. A further requirement is that the portable device should be kept relatively simple insofar as the data gathering from beacons is concerned.

The Applicant has proposed (but not published) a system (in commonly assigned International patent application PCT/EP 01/06948, priority date Aug. 15, 2000) in which data is broadcast to a CA terminal before a connection is made according to Bluetooth protocols. This system exploits the Bluetooth Inquiry phase by extending the very short ID packet sent out during this mode and using extra space thus gained to carry a small amount of information. This information can be Bluetooth system related data or one-way application data. This scheme has the advantage of being backwards-compatible with legacy Bluetooth devices that are not able to understand this extra field.

Several applications can exploit this feature, for example wireless local area network (WLAN) access. The extra field may provide location information to enable a CA mobile telephone to determine rapidly its own location.

To help two Bluetooth transceivers find each other, the Inquiry procedure is restricted to a specially chosen set of 32 channels from the 79 available and to a special hopping sequence inherently known by all Bluetooth transceivers. Since the broadcast data field is attached to the ID packets, it follows the same pattern. This raises a potential conflict with the FCC regulations concerning the 2.4 GHz ISM band, which broadly state that information transfer must be spread over the entire ISM band.

There are two principle classes of spread spectrum radio system, which occupy a wide bandwidth compared to the data rate to be communicated, in order to statistically smear out interference to other band users. Frequency Hopping radio systems are known, and Direct Sequence systems are known. Systems are also known that are a hybrid of the two, with direct sequence spreading of a data stream, the carrier hopping periodically from one frequency to another. These are all specifically allowed for in the FCC regulations for the ISM band at 2.4 GHz.

According to a first aspect of the invention, there is provided a communications system comprising at least one beacon device capable of wireless message transmission and at least one portable device capable of receiving such a message transmission, wherein the beacon is arranged to broadcast messages using a first protocol which provides a series of inquiry messages, different inquiry messages in the series being provided on different carrier frequencies, and wherein the beacon is arranged to broadcast additional data using a spread spectrum transmission technique.

The use of two different modes of operation enables one mode (the spread spectrum transmission technique) to be used for one type of data to which the technique is most suited, and enables the other mode (the frequency hopping technique) to be used for other types of data. For example, the spread spectrum transmission technique can be used to enable an unsynchronised receiver to establish communication in a short time, so that data can be sent to the receiver as quickly as possible. The frequency hopping technique may require a longer call set-up procedure, but provides a more appropriate communications protocol for bi-directional transfer of larger quantities of data.

In one embodiment, the spread spectrum transmission technique comprises a single channel direct spread spectrum sequence transmission system. This system can be independent of the first protocol, so that the provision of additional data does not affect the protocol used for the transmission of the inquiry messages.

In another, preferred, embodiment, the additional data may be incorporated into the structure of the data sent using the first protocol. For example, the inquiry messages may each be in the form of a plurality of predetermined data fields and the beacon may be arranged to add to each inquiry message prior to transmission an additional data field for the additional data.

The use of a spread spectrum arrangement for the additional data, which is incorporated into the inquiry message of the first protocol system, spreads the signal, thereby increasing robustness to sources of interference, and satisfies regulatory requirements.

By adding the additional field (suitably at the end of a respective inquiry message), data broadcast may be carried on top of an existing inquiry process, such that the usual delays while such a process is carried out prior to data transfer are avoided. Furthermore, by placing the additional field at the end of those sent according to the first protocol (preferably but not essentially Bluetooth), those protocol-compatible devices not intended for reception of beacon signals can simply ignore the additional data without compromising operation according to the first protocol.

The additional data is preferably spread using a sequence. For example, the additional data may comprise data at 91 kb/s spread at a rate of 1 Mb/s with an 11 bit code.

Regardless of how the additional data is sent (within or separately to the inquiry messages), the additional data may enable a portable device and the beacon device to commence wirelessly exchanging data using the first protocol. Thus, the additional data may be used to improve the efficiency of the call set-up procedure of the first protocol system. For example, the portable device and the beacon device may commence wirelessly exchanging data without further use of the inquiry messages.

The system may be compatible for portable devices of a first type and a second type. A portable device of the first type is arranged to receive the transmitted inquiry messages and receive the additional data, whereas a portable device of the second type is arranged to receive the transmitted inquiry messages but not to receive said additional data. The devices of the second type can thus be conventional devices which communicate using the first protocol.

Where the first protocol is Bluetooth (or a similar frequency hopping arrangement) the beacon may be configured to broadcast a series of inquiry messages on a predetermined clocked sequence of frequencies, with clock information for the beacon being carried by the additional data. As will be described in greater detail hereinafter with respect to embodiments of the invention, this can improve the inquiry performance of a Bluetooth system.

The beacon may be arranged to include an indication in a data field of the inquiry message (suitably in a currently unused or unassigned field), said indication denoting the presence of an additional data field, such that devices configured for reception of beacon data may be triggered to read from the additional data field.

Also in accordance with the present invention there is provided a mobile communication device for use in the system of the invention, the device comprising a receiver capable of receiving a short-range wireless inquiry message according to a first communications protocol and additional data broadcast using a spread spectrum transmission technique, the device further comprising means for reading the additional data and presenting the same to a user.

Further in accordance with the present invention, there is provided a beacon device capable of wireless message transmission and for use in a communications system comprising said beacon device and at least one portable device capable of receiving such a message transmission, wherein the beacon device is configured to broadcast a series of inquiry messages arranged according to a first protocol, and to broadcast additional data using a spread spectrum transmission technique.

Still further in accordance with the present invention, there is provided a method of communicating between a beacon device and a portable communications device, comprising:

transmitting a series of inquiry messages arranged according to a first protocol, different inquiry messages in the series being provided on different carrier frequencies, and broadcasting additional data using a spread spectrum transmission technique, wherein the portable device receives the additional data and determines therefrom whether or not to communicate with the beacon device using the first protocol.

Preferred embodiments of the invention will now be described, by way of example only, and with reference to the accompanying drawings, in which:

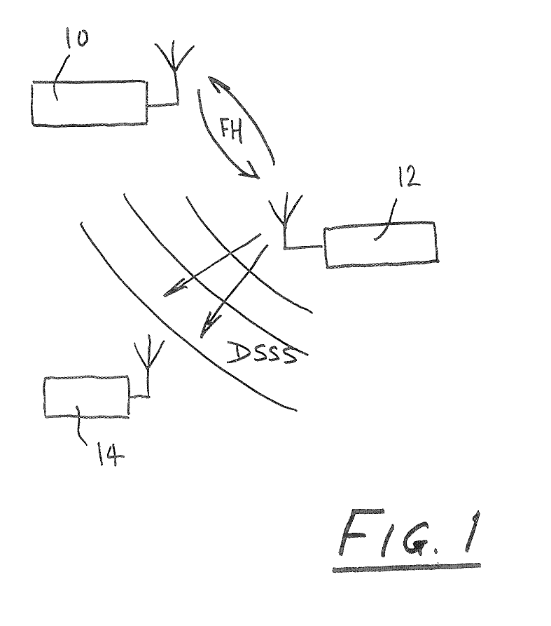

FIG. 1 shows a system of the invention in which two different types of portable devices are within range of a beacon device;

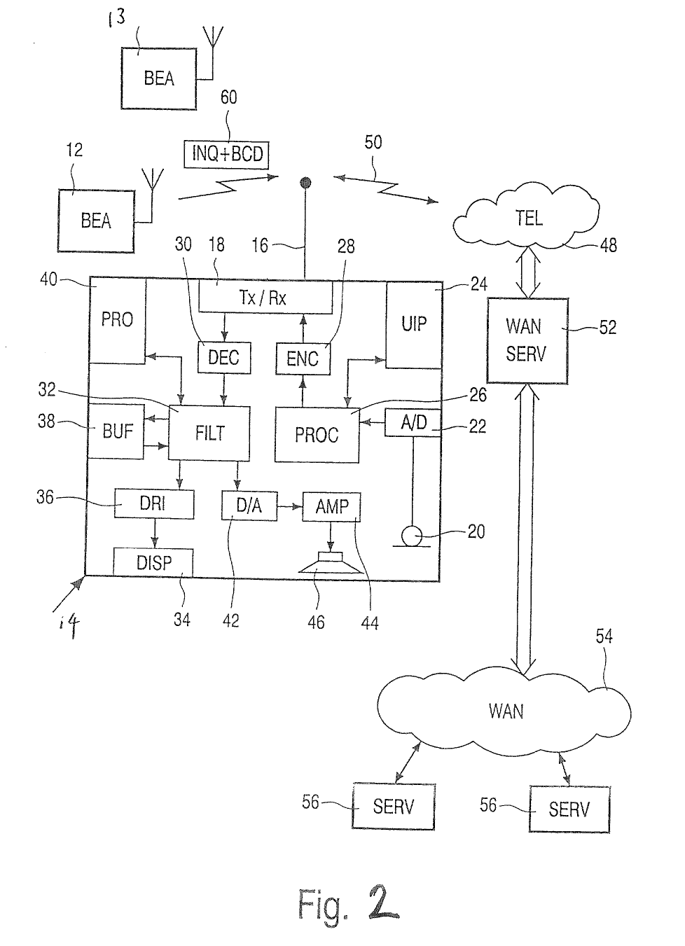

FIG. 2 is a block schematic diagram of a beacon and portable device embodying the invention;

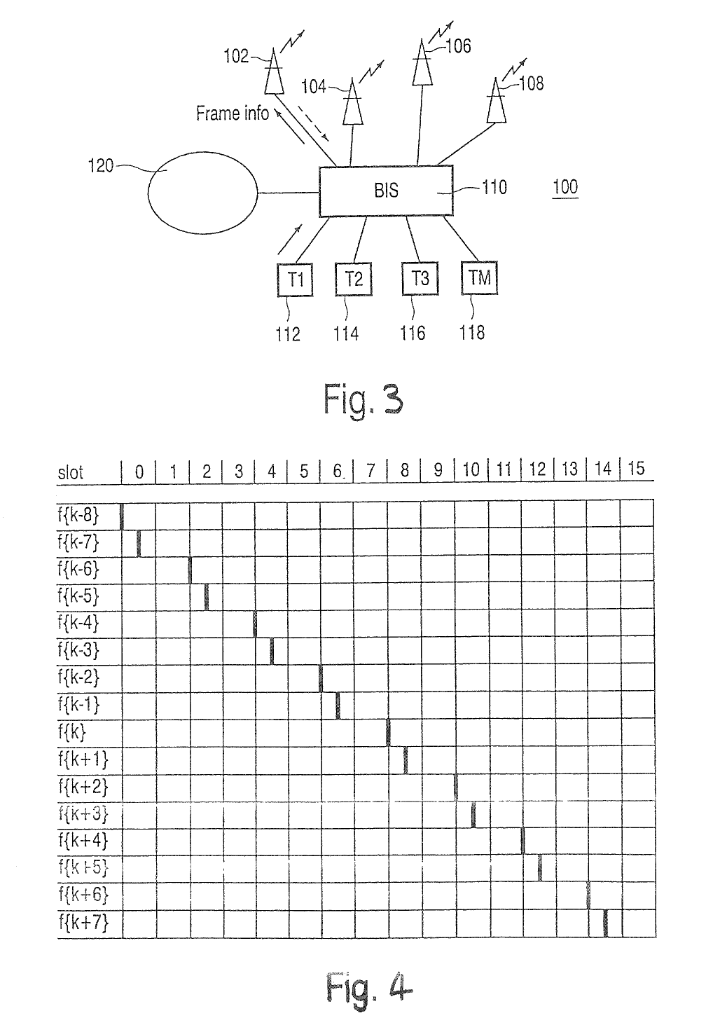

FIG. 3 is a schematic diagram of a series of devices in a linked beacon infrastructure;

FIG. 4 is a chart illustrating the transmission of a train of inquiry access codes centred on a given frequency;

FIG. 5 illustrates alternation between trains of inquiry messages over the duration of an inquiry broadcast;

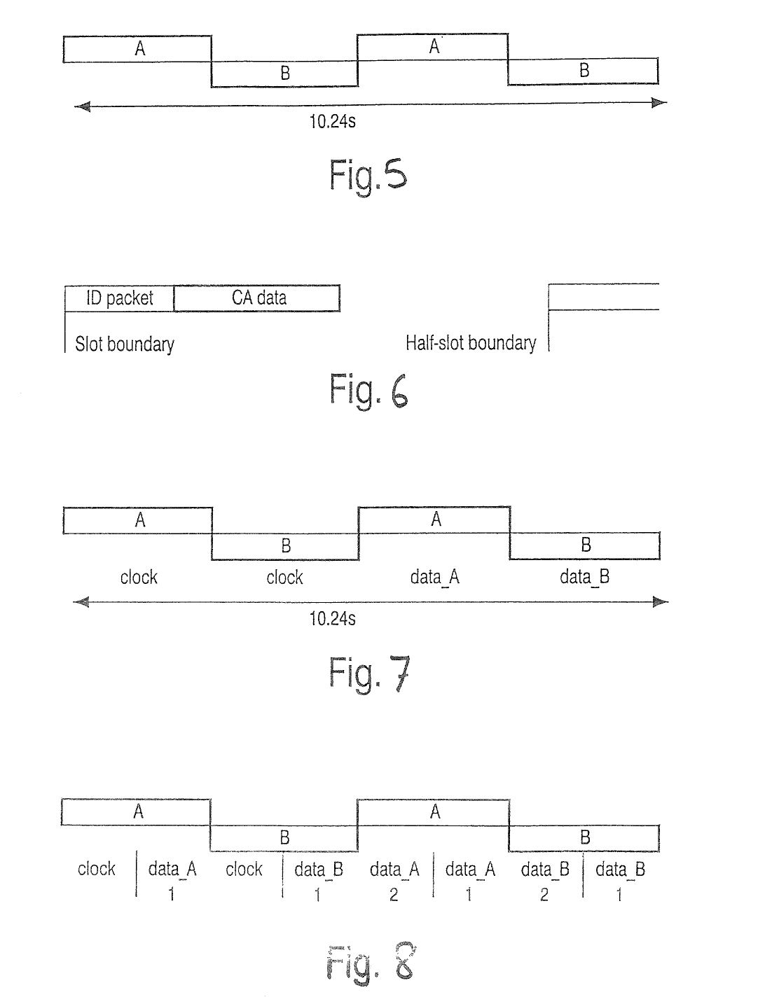

FIG. 6 illustrates the insertion of a packet of broadcast data within an existing transmission slot;

FIG. 7 illustrates a first arrangement for sending beacon clock data in a sequence of inquiry message trains; and

FIG. 8 illustrates an alternate arrangement to that of FIG. 6 for the sending of beacon clock data.

In the following description we consider particularly a CA application which utilises Bluetooth protocols for communication of messages from beacon to portable device (whether telephone, PDA or other). As will be recognised, the general invention concept of including a broadcast channel as part of the inquiry procedure is not restricted to Bluetooth devices, and is applicable to other communications arrangements, in particular frequency hopping systems.

Referring to FIG. 1, a communications system comprises at least two devices 10, 12 capable of networking by wirelessly exchanging data according to a first mode of operation FH, such as frequency hopping. The first mode of operation is in accordance with a first protocol. One of the devices 10 is a portable device, and the other 12 is a beacon device. The beacon device 12 further wirelessly broadcasts data according to a second mode of operation DSSS, using for example a direct sequence spread spectrum. The communication between the beacon 12 and the portable device 10 may use the Bluetooth messaging protocol, which has a lengthy call set-up procedure (in a so-called “inquiry” phase). The portable device 10 may be a conventional Bluetooth apparatus. The DSSS communication link is set up to enable specially adapted portable devices to receive limited amounts of data without completing this inquiry phase.

A third device 14 is adapted in accordance with the invention, and is thus configured to receive the DSSS data broadcast, and may therefore acquire data without having to complete the inquiry phase to join the Bluetooth network of the other devices, or as a precursor to joining the Bluetooth network.

The reason for the applicant's selection of DSSS is that it removes the requirement (under the regulations, and for system robustness) for a long hop sequence, and therefore allows faster finding of the signal by an unsynchronised receiver. This reduces the latency required to be able to receive messages.

Where message transmission according to Bluetooth protocols is supported, the Bluetooth system takes advantage of this for sending fixed messages, which can be argued in themselves to represent spreading sequences.

In one example, data information is sent over the channel in this DSSS mode by spreading it with a sequence. This provides a means of broadcasting information to devices wishing to join the network without them having to go through the time-consuming process of searching for a long hop sequence of the FH transmission system.

The DSSS mode may be a single channel, allocated specifically for this purpose, or a limited number of channels, over which the transmitter hops. This latter provides some robustness against interference, though without the excessive synchronisation implications of a full hopping system.

The two modes of operation may take place in an interlaced manner, using the same radio operating in pure frequency hopping for some data communication tasks and using DSSS for different data communication tasks. The gross bearer data rate over the air can be maintained at the same rate for both modes, simplifying radio design, if the net data rate to be sent using the DSSS mode is reduced by an amount corresponding to the length of the spreading code imposed. Though this reduces the data rate that can be supported, it does also improve robustness to noise and interference.

Alternatively, the two functions of the system, namely the provision of broadcast and/or acquisition information and traffic-carrying can be implemented in different radios using the corresponding different modes (DSSS and pure frequency hopping), with the information to be communicated by each coordinated accordingly.

Various possible implementations of the invention have been outlined briefly above. One preferred implementation of the invention will now be described in greater detail, in which the first protocol communication is Bluetooth messaging, and the additional data is integrated into the structure of the Bluetooth data format.

FIG. 2 is a block schematic diagram of a CA mobile telephone 14 in use with one or more low power, short range base stations or beacons 12, 13. As mentioned previously, and discussed in greater detail below, such an arrangement may be used in places like shopping malls to provide location-specific information such as local maps, information on nearby shops and restaurants and so on, with the beacon downloading information keys to a mobile device. An information key is a small data object that provides a reference to a source of full information, and it is in the form of a number of predetermined fields, one of which will contain a short piece of descriptive text presented to a user. Another field will be a pointer or address of some form, for example a URL or telephone number. Other supplementary fields may control how the data is presented to a user and how the address may be exploited. The beacon will generally broadcast cyclically a number of these keys, each typically relating to a different service.

Issues relating to the beacon construction and configuration include the beacon range which will be dependent on output power (typical range being 1 mW to 100 mW), levels of local interference, and receiver sensitivity.

The user's CA telephone 14 comprises an aerial 16 coupled with transceiver stage 18 for the reception and transmission of messages. Outgoing messages result from user input to the telephone, either audio input via microphone 20 and A/D converter 22 or other data input via the keypad or other input means 24. These inputs are processed to message data format by signal and data processing stage 26 and converted to transmission format by encoder 28 before being supplied to the transceiver stage 18.

Messages received via the aerial 16 and transceiver 18 are passed via a decoding stage 30. This stage operates according to the Bluetooth protocol and thereby enables the inquiry messages and page messages to be read. In addition, in accordance with the invention, the decoding stage also allows additional data in a DSSS format to be decoded. For example, this may require a selected part of an input data stream to be combined with a spreading code to recover the original data stream. The decoded data is supplied to a filtering and signal processing stage 32. If the data carried by the message is for presentation on a display screen 34 of the telephone, the data will be passed to a display driver 36, optionally after buffering 38, with the driver formatting the display image. As will be recognised, the display 34 may be a relatively simple low-resolution device, and the conversion of received data to display data may be carried out as a subset of the processing stage 32 functionality, without the requirement for a dedicated display driver stage.

Where the message is carrying data from one or other of the beacons 12, 13, the telephone has the ability to filter the information received according to pre-stored 40 user preferences and the user is only alerted (i.e. the information will only be retained in buffer 38 and/or presented on screen 34) if comparison of stored preference data and subject matter indicators in the message indicate that an item of data of particular interest has been received.

For conventional audio messages, the audio data is output by the filter and processing stage 32, via D/A converter 42 and amplifier 44 to an earphone or speaker 46. Receipt of such messages from the telephone network 48 is indicated by arrow 50: the telephone network 48 also provides the link from the telephone 14 to a wide-area network (WAN) server 52 and, via the WAN 54 (which may be the internet), to one or more remote service providers 56 providing a source of data for the telephone 14.

Communication between the CA terminal (telephone 14) and the CA base station (beacon 12) takes two forms: ‘push’ and ‘pull’. In ‘push’ mode, information is broadcast by the beacons 12, 13, to all portable terminals in the form of short ‘keys’ indicated at 60. The keys will take various forms according to the application but will generally include a concise description of the information being sent and a pointer to fuller information, e.g. a URL identifying one of the service providers 56.

Keys are received by the terminal 14 ‘unconsciously’, that is, without direct intervention by the user, and automatically filtered according to the user's pre-set preferences by a comparator function applied in the filtering and processing stage 32. Suitably, the processing stage is operable to apply the comparator function in multiple simultaneous or overlapping copies such as to process in parallel the relatively large number of keys that may be received. Some will be discarded, some kept for further study, others might cause the user to be alerted immediately. By way of example, shops might choose to push details of special offers into passing terminals in the knowledge that users who have interest and have therefore set their filters 32 accordingly will be alerted by their terminal.

Sometimes the user will wish to obtain more information than is contained in the keys. Here, ‘pull’ mode allows a user to set up a connection with a server 56 (which need not necessarily be specially configured for CA use) and actively request information to pull down into the terminal 10. This mode is therefore typically interactive.

Whilst base stations or beacons will typically be independent of one another (in a shopping mall set up, each shop provides and maintains its own beacon without reference to any beacons provided by neighbouring shops), the beacons may be wholly or partially networked with at least some coordination as to their broadcast messages.

FIG. 3 is a diagram of such a system 100 of linked beacons embodying the invention and providing an implementation of an infrastructure for use in, for example, department stores, shopping malls, theme parks, etc. The system 100 comprises a plurality of beacons 102, 104, 106, 108 distributed over a series of locales. Each of the beacons 102-108 broadcasts one or more short-range inquiry signals in a time-slot format as described in greater detail hereinafter. The beacons 102-108 are controlled by a beacon infrastructure server (BIS) 110, with one or more terminals 112, 114, 116, 118 being connected to the server 110. The terminals 112-118 enable service providers, i.e., the users of beacons 102-108, to author or edit allocated service slots in the form of added data piggy backed on inquiry facilitation signals transmitted by beacons 102-108. A service provider may lease a beacon or one of the beacon's service slots from the infrastructure provider. To this end, server 110 provides simple HTML templates for filling out by the user via one of terminals 112-118. Having filled out the template with, for example, a description of the service and other information for the data to be carried via the beacon broadcast, the template is returned to server 110, preferably via a secure link using, e.g., Secure HTTP (S-HTTP) or Secure Sockets Layer (SSL). SSL creates a secure link between a client and a server, over which any amount of data can be sent securely. S-HTTP is designed to transmit individual messages securely. Server 110 then creates the appropriate additional data package for appending to the inquiry signal of a relevant one of the beacons 102-108 based on the information submitted with the template. The system 100 may further comprise an application server 120 to assist in carrying out various functions, as will be readily understood by the skilled reader.

Referring back to FIG. 2, a strong candidate technology for the wireless link necessary for at least the ‘push’ mode of the above-described CA system is Bluetooth, on the grounds that it is expected to become a component part of a large number of mobile telephones. In analysing the Bluetooth protocol for CA broadcast or ‘push’ mode utilisation, a problem may be seen. In the ideal case, the terminal 14 will detect fixed beacons 12, 13 and extract basic information from them without the terminal 14 needing to transmit at all. However, this type of broadcast operation is not supported by the current Bluetooth specification.

In part, the incompatibility follows from the frequency hopping nature of Bluetooth beacon systems which means that, in order for broadcast messages (or, indeed, any messages) to be received by a passing terminal, the terminal has to be synchronised to the beacon in both time and frequency. The portable device 14 has to synchronise its clock to the beacon clock and, from the beacons identity, deduce which of several hopping sequences is being employed.

To make this deduction, the portable device has conventionally been required to join—as a slave—the piconet administered by the beacon as piconet master. Two sets of procedures are used, namely “inquiry” and “page”. Inquiry allows a would-be slave to find a base station and issue a request to join the piconet. Page allows a base station to invite slaves of its choice to join the net. Analysis of these procedures indicates that the time taken to join a piconet and then be in a position to receive information from the master could be several tens of seconds, which is much too long for CA applications, where a user may move out of range of a beacon before joining could be completed.

The difficulty of receiving broadcast data from beacons is caused at least partially by the frequency-hopping nature of Bluetooth and similar systems. The Bluetooth inquiry procedure has been proposed specifically to solve the problem of bringing together master and slave: the applicants have recognised that one possible implementation of the invention can be achieved by piggy-backing a broadcast channel encoded using a DSSS technique on the inquiry messages issued by the master. Only CA terminals need read the broadcast channel messages and only CA base stations or beacons send them. In consequence, at the air interface, the mechanism is entirely compatible with conventional (non-CA) Bluetooth systems, such as portable device 10 shown in FIG. 1.

To illustrate how this preferred implementation of the invention is implemented, we first consider how the Inquiry procedures themselves operate, with reference to FIGS. 4 and 5. When a Bluetooth unit wants to discover other Bluetooth devices, it enters a so-called inquiry substate. In this mode, it issues an inquiry message containing a General Inquiry Access Code (GIAC) or a number of optional Dedicated Inquiry Access Codes (DIAC). This message transmission is repeated at several levels; first, it is transmitted on 16 frequencies from a total of 32 making up the inquiry hopping sequence. The message is sent twice on two frequencies in even timeslots with the following, odd timeslots used to listen for replies on the two corresponding inquiry response hopping frequencies. Sixteen frequencies and their response counterparts can therefore be covered in 16 timeslots, or 10 ms. The chart of FIG. 4 illustrates the transmission sequence on sixteen frequencies centred around f{k}, where f{k} represents the inquiry hopping sequence.

The next step is the repetition of the transmission sequence at least N_{inquiry} times. At the very least, this should be set at N_{inquiry}=256 repetitions of the entire sequence which constitutes a train of transmissions which we refer to as inquiry transmission train A. Next, inquiry transmission train A is swapped for inquiry transmission train B consisting of a transmission sequence on the remaining 16 frequencies. Again, the train B is made up of 256 repetitions of the transmission sequence. Overall, the inquiry transmission cycle between transmissions of train A and train B. As shown by FIG. 4, the specification states that this switch between trains must occur at least three times to ensure the collection of all responses in an error-free environment. This means that an inquiry broadcast could take at least 10.24 seconds.

One way to reduce this would be for the switch between inquiry transmission trains to be made more rapidly, i.e. without waiting until the 2.56 seconds for 256 repetitions of the 10 ms to cover the 16 timeslots is up. This may suitably be accomplished by setting the systems to switch over if no inquiry message is detected after say 50 ms, on the understanding that no such message will be detected in the remainder of the present train.

A portable device that wants to be discovered by a beacon enters the inquiry scan substate. Here, it listens for a message containing the GIAC or DIAC's of interest. It, too, operates in a cyclic way. It listens on a single hop frequency for an inquiry scan period which must be long enough to cover the 16 inquiry frequencies used by the inquiry. The interval between the beginning of successive scans must be no greater than 1.28 seconds. The frequency 30 chosen comes from the list of 32 making up the inquiry hopping sequence.

On hearing an inquiry containing an appropriate IAC, the portable device enters a so-called inquiry response substate and issues a number of inquiry response messages to the beacon. The beacon will then page the portable device, inviting it to join the piconet.

In the preferred embodiment of the invention, the additional data is provided by virtue of a modification to the Bluetooth inquiry mode. The additional data to be sent (at 1 Mb/s/11=91 kb/s) is appended to the inquiry message after first being passed through an exclusive-or with an 11 bit Barker code sequence running at 1 Mb/s. This performs the required spreading of the raw data to form a bearer data rate of 1 Mb/s.

In the receiver, the 1 Mb/s data stream is recovered in the normal way, and the data appended at the end of the inquiry message is passed through a corresponding 11-bit sequence to recover the original 91 kb/s broadcast data stream. This is carried out in the decoder 30 (FIG. 2). The additional data is provided in an extra field appended to the inquiry messages issued by the base station, the extra field being capable of carrying a user-defined payload. FIG. 6 shows the inquiry message structure, in which the user-defined payload CA DATA is appended after the inquiry message “ID packet”.

In the CA scenario, this CA DATA payload is used to carry broadcast information, or keys, to CA terminals during the inquiry procedure. By adding the field to the end of the inquiry message, it will be appreciated that non-CA receivers can ignore it without modification. In addition, by using a CA-specific DIAC, CA receivers can be alerted to the presence of the extra information field.

By spreading the CA DATA payload, the resistance to narrow band interference is improved. This improves system robustness and also enables regulatory approval to be obtained.

The presence of the extra data field means that the guard space conventionally allowed at the end of a Bluetooth inquiry packet (shown in FIG. 6) is reduced. However, this space—provided to give a frequency synthesiser time to change to a new hop frequency—will be generally unused otherwise, as current frequency synthesisers are capable of switching at speeds which do not need extension into the extra guard space. The standard inquiry packet is an ID packet of length 68 bits. Since it is sent in a half-slot, the guard space allocated is (625/2−68)=244.5 ps (625 μs slot period, 1 Mbit/s signalling rate). Modern synthesisers can switch in much less time with figures of 200 μs or lower (even as low as 100 μs) considered routine by experts in the field.

One possible use of a part of the guard space is an allocation of 136 bits as a suitable size for this new additional data field, although it will be readily understood that other field sizes are, of course, possible. A smaller number of bits, for example 100, will allow greater switching time if required.

CA handsets can receive the broadcast data quickly without being required to run through a lengthy procedure to join a piconet. In addition, since there is no need for the handset to transmit any information whatsoever, there is a consequent power saving that will be particularly important in dense environments where many CA base stations may be present. Nevertheless, when the handset is in interactive mode and wishes to join a piconet in order to obtain more information, it may employ the default inquiry procedures as normal. There is no loss of functionality through supporting the additional data field.

In a typical embodiment, four of our 136 bits will be lost as trailer bits for the ID field; this is a consequence of it being read by a correlator. Of the 132 bits remaining, applicants preferred allocation is that 88 be used as data and 44 as a ⅔ FEC (forward error correction) checksum. Each inquiry burst thus contains 11 bytes of additional data. After reconstitution using the 11 bit code, 1 byte of additional data is derived. An alternative to the FEC uses Barker Sequence Coding, which does not require additional FEC bits.

In a most common scenario, by the second group of A and B trains the portable device has found the base station, understood it to be a CA beacon and is awaiting the broadcast data. Since it will be listening specifically, the portable device will at least be able to read 256 bursts of data twice (A and B), giving us two lots of 256 bytes, or 512 bytes in total.

At this stage, the portable device does not know the phase of the beacon clock because this information is not been transmitted. To assist the portable device, clock information is transmitted in at least some of the trains in the first A and B groups, as shown in FIG. 7, together with some auxiliary information indicating when the next switches between A and B will occur. This clock information will be transmitted in place of the CA broadcast data so means are provided to discriminate between the two data channels. Use of separate DIAC's is one possible method.

In the case where the portable device knows the timing of the beacon, the portable devices also knows how it will hop, which gives the ability to track all transmissions of a train. Since there are 16 transmissions in a frame, then the resultant CA channel has 16 times as much capacity and can convey 8 Kbytes of information.

Since the terminal wakes up every 1.28 seconds or less, it will generally have obtained the clocking information it needs by the half way mark in the first A or B periods. Switching from clock to data at these halfway marks, as illustrated in FIG. 8, provides a number of useful advantages. Firstly, some data can be received in less than five seconds from the start of the inquiry procedure. Secondly, the terminal can still respond to an important key by automatically issuing an inquiry response message to the base station (if that is the appropriate action for the terminal to take) even if the key appears comparatively late in the cycle. It will be noted that no increase in capacity is assumed.

In the foregoing, a portable device will receive all the additional data field packets on one of the 32 inquiry channels, thereby using only 1/32 of the available bandwidth. As will be recognised, if the uncertainty as to when a portable terminal (beacon slave) receives the first inquiry packet can be overcome, the predetermined nature of the hopping sequence may be accommodated and the full bandwidth therefore utilised. For a slave to synchronise with a masters inquiry hopping sequence from the point where it received the first packet, the slave needs to know both the masters clock offset and the position of the first received packet in the masters hopping sequence. An alternative method of synchronising the slave hopping is to transmit clocking data in every broadcast field. This will not be described in detail.

The rapidly obtained additional data can be used by the portable device to identify the beacon within range. This information can then be used to enable communication to be established between the portable device and the beacon more rapidly using the first protocol system. In the case of Bluetooth as the first protocol, the inquiry procedure can be bypassed, and the additional DSSS data can thus be used to reduce the call set-up time for establishing a bi-directional Bluetooth link. For this purpose, the decoder 30 (FIG. 2) enables the Bluetooth set-up procedures to be short cut. Thus, the Inquiry step of the Bluetooth process can effectively be completed using the additional data. As the Bluetooth process generally cycles through Inquiry and Interaction phases, there can be a delay waiting for the next Inquiry phase to cycle round. The invention avoids the need to wait, as the same data may be sent immediately via another protocol, and the Bluetooth interaction phase can then go ahead.

In the example described above, the additional data is integrated into the structure of the Bluetooth inquiry messages. In a second embodiment of the invention, a combination of two systems is provided—a frequency hopping system (such as Bluetooth) is combined with a different protocol single channel DSSS system (such as “Lite”—otherwise known as “ZigBe”). Broadcast and registration/synchronisation information are communicated over the Lite system, and traffic channels are set up using the Bluetooth system as desired. The two systems can be served by a single device if desired, by periodically switching between modes of operation.

Again, the DSSS data can be used to improve the efficiency of the call set-up procedure of the frequency hopping system.

From reading the present disclosure, other modifications will be apparent to persons skilled in the art. Such modifications may involve other features which are already known in the design, manufacture and use of fixed and portable communications systems, and systems and components for incorporation therein and which may be used instead of or in addition to features already described herein.

1. A communications system comprising at least one beacon device capable of wireless message transmission and at least one portable device capable of receiving such a message transmission, wherein the beacon is arranged to broadcast messages using a first protocol which provides a series of inquiry messages, different inquiry messages in the series being provided on different carrier frequencies, and wherein the beacon is arranged to broadcast additional data using a spread spectrum transmission technique.

2. A system as claimed in claim 1, wherein the inquiry messages are each in the form of a plurality of predetermined data fields and wherein the beacon is arranged to add to each inquiry message prior to transmission an additional data field for the additional data.

3. A system as claimed in claim 2, wherein the beacon is arranged to add said additional data field at the end of a respective inquiry message.

4. A system as claimed in claim 2, wherein the beacon is arranged to include an indication in one of said predetermined data fields, said indication denoting the presence of said additional data field.

5. A system as claimed in claim 2, wherein said additional data field carries at least 64 bits of data.

6. A system as claimed in claim 2, wherein the additional data is spread using a sequence.

7. A system as claimed in claim 6, wherein the additional data comprises data at 91 kb/s spread at a rate of 1 Mb/s with an 11 bit code.

8. A system as claimed in claim 1, wherein the spread spectrum transmission technique comprises a single channel direct spread spectrum sequence transmission system.

9. A system as claimed in claim 1, wherein the additional data enables a portable device and the beacon device to commence wirelessly exchanging data using the first protocol.

10. A system as claimed in claim 9, wherein the additional data enables a portable device and the beacon device to commence wirelessly exchanging data using the first protocol without use of the inquiry messages.

11. A system as claimed in claim 1, wherein the system comprises at least one portable device of a first type and at least one portable device of a second type, and wherein a portable device of the first type is arranged to receive the transmitted inquiry messages and receive said additional data, whereas a portable device of the second type is arranged to receive the transmitted inquiry messages but not to receive said additional data.

12. A system as claimed in claim 1, wherein said first protocol comprises Bluetooth messaging.

13. A system as claimed in claim 12, wherein the beacon is configured to broadcast a series of inquiry messages on a predetermined clocked succession of frequencies, with clock information for said beacon being included in said additional data.

14. A mobile communication device for use in the system of claim 1, the device comprising a receiver capable of receiving a short-range wireless inquiry message according to a first communications protocol and additional data broadcast using a spread spectrum transmission technique, the device further comprising means for reading the additional data and presenting the same to a user.

15. A device as claimed in claim 14, wherein the receiver is configured to receive messages according to Bluetooth protocols.

16. A beacon device capable of wireless message transmission and for use in a communications system comprising said beacon device and at least one portable device capable of receiving such a message transmission, wherein the beacon device is configured to broadcast a series of inquiry messages arranged according to a first protocol, and to broadcast additional data using a spread spectrum transmission technique.

17. A device as claimed in claim 16, wherein the beacon is configured to add to each inquiry message prior to transmission an additional data field for the additional data, the beacon device further comprising means for spreading the additional data within the additional data field.

18. A beacon device as claimed in claim 17 arranged to include an indication in the inquiry message, said indication denoting the presence of said additional data field.

19. A beacon device as claimed in claim 16, wherein said first protocol comprises Bluetooth messaging.

20. A method of communicating between a beacon device and a portable communications device, comprising:
transmitting a series of inquiry messages arranged according to a first protocol, different inquiry messages in the series being provided on different carrier frequencies, and
broadcasting additional data using a spread spectrum transmission technique,
wherein the portable device receives the additional data and determines therefrom whether or not to communicate with the beacon device using the first protocol.

21. A method as claimed in claim 20, wherein the additional data enables the portable device to establish communication with the beacon device without use of the inquiry messages.

22. A method as claimed in claim 20, wherein said first protocol comprises Bluetooth messaging.
